(19) United States
(12) Patent Application Publication
(10) Pub. No.: US 2014/0130872 A1
(43) Pub. Date: May 15, 2014

(54) PHOTOELECTRIC-CONVERSION DEVICE, ELECTRONIC INSTRUMENT AND BUILDING

(71) Applicants: Masaki Orihashi, Kanagawa (JP); Hiroko Miyashita, Kanagawa (JP); Kiyoshi Kumagae, Kanagawa (JP); Kenji Matsuda, Kanagawa (JP); Kotaro Satori, Kanagawa (JP)

(72) Inventors: Masaki Orihashi, Kanagawa (JP); Hiroko Miyashita, Kanagawa (JP); Kiyoshi Kumagae, Kanagawa (JP); Kenji Matsuda, Kanagawa (JP); Kotaro Satori, Kanagawa (JP)

(73) Assignee: Sony Corporation, Tokyo (JP)

(21) Appl. No.: 14/232,399

(22) PCT Filed: Jun. 22, 2012
(86) PCT No.: PCT/JP2012/066627

§ 371 Date: Jan. 13, 2014

(30) Foreign Application Priority Data
Jul. 22, 2011 (JP) 2011-161195

(51) Int. Cl. H01G 9/20

(52) U.S. Cl. CPC H01G 9/2059
USPC 136/263

(57) ABSTRACT

Provided is a photoelectric-conversion device, an electronic instrument, and a building which can suppress long-term performance degradation by suppressing dye desorption or dye aggregation. The photoelectric-conversion device includes a conductive electrode, a porous semiconductor layer, a counter layer, and an electrolyte layer, and the porous semiconductor layer contains a dye and a phosphorous compound such as a decylphosphonic acid. The molar ratio of the phosphorous compound to the dye is 0.5 or more.

### TECHNICAL FIELD

The present technique relates to a photoelectric-conversion device, an electronic instrument, and a building, and relates to, for example, a photoelectric-conversion device preferably for use in a dye-sensitized solar cell, as well as an electronic instrument and a building using the photoelectric-conversion device.

### BACKGROUND ART

Photoelectric-conversion devices such as a dye-sensitized solar cell (DSSC) have features such as availability of electrolytes, inexpensive raw materials and manufacturing costs, and decorations due to the use of dyes, and have been actively studied in recent years. In general, the photoelectric-conversion device is composed of a substrate with a conductive layer formed, a dye-sensitized semiconductor layer of a semiconductor microparticle layer (such as a TiO₂ layer) combined with a dye, a charge transport agent such as iodine, and a counter electrode.

For example, Patent Document 1 discloses a dye-sensitized solar cell in which a compound for densification, containing a hydrophobic moiety and an anchoring group, is coadsorbed along with a dye onto a semiconductor metal oxide layer of a photoanode to form a dense mixed self-assembled monolayer.

### CITATION LIST

### Patent Document

Patent Document 1: JP 2006-525632 W

### SUMMARY OF THE INVENTION

### Problems to be Solved by the Invention

The dye-sensitized solar cell is also likely to cause dye desorption, and also tends to undergo a long-term decrease in performance, as the environmental temperature around the cell is increased. In addition, when the dye adsorbs onto the surface of the TiO₂ layer, aggregation will be also caused, and a dye will be also present which makes no contribution to power generation.

Therefore, an object of the present technique is to provide a photoelectric-conversion device, an electronic instrument, and a building which can suppress long-term performance degradation by suppressing dye desorption or dye aggregation.

### Solutions to Problems

In order to solve the problems mentioned above, the present technique provides a photoelectric-conversion device including a conductive layer, a porous semiconductor layer, a counter electrode, and an electrolyte layer, where the porous semiconductor layer contains a dye and a phosphorous compound represented by the general formula (A), and the molar ratio of the phosphorous compound to the dye is 0.5 or more.

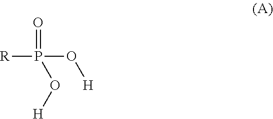

(In the formula, R is a linear alkyl group having 8 to 16 carbon atoms.)

According to the present technique, the photoelectric-conversion device is preferably applied to an electronic instrument.

According to the present technique, the photoelectric-conversion device is preferably applied to a building.

According to the present technique, the porous semiconductor layer includes a dye and a coadsorbent adsorbed onto the porous semiconductor layer, the dye contains a ruthenium complex, and the coadsorbent contains a phosphorous compound represented by the general formula (A), and the molar ratio of the phosphorous compound to the dye is set to 0.5 or more. Thus, dye desorption or dye aggregation can be suppressed to suppress long-term performance degradation.

### Effects of the Invention

According to the present technique, dye desorption or dye aggregation can be suppressed to suppress long-term performance degradation.

### BRIEF DESCRIPTION OF DRAWINGS

FIG. 1A is a plan view illustrating a configuration example of a photoelectric-conversion device according to a first embodiment of the present technique. FIG. 1B is a cross-sectional view of FIG. 1A along the line B-B.

FIG. 2 is a pattern diagram illustrating a dye and a coadsorbent adsorbed onto a TiO₂ microparticle.

FIG. 3A is a cross-sectional view illustrating a step of applying a semiconductor paste. FIG. 3B is a cross-sectional view illustrating a firing step. FIG. 3C is a cross-sectional view illustrating a step of immersing a porous semiconductor layer in a dye solution. FIG. 3D is a cross-sectional view illustrating a step of attaching a conductive base material. FIG. 3E is a cross-sectional view illustrating a step of injecting an electrolyte solution.

FIGS. 4A to 4C are diagrams illustrating examples of a building according to the present technique.

FIG. 5 is a graph showing measurement results for Examples 1-1 to 1-3 and Comparative Example 1.

FIG. 6 is a graph showing measurement results for Test Example 1.

FIG. 7 is a graph showing measurement results for Examples 2-1 to 2-3 and Comparative Example 2.

FIG. 8 is a graph showing measurement results for Test Example 2.

### MODES FOR CARRYING OUT THE INVENTION

Embodiments of the present technique will be described below with reference to the drawings. Explanations will be given in the following order.

### 1. First Embodiment (Configuration Example of Photoelectric-Conversion Device)

2. Second Embodiment (Configuration Example of Building including Photoelectric-Conversion Device)
3. Third Embodiment (Configuration Example of Electronic Instrument including Photoelectric-Conversion Device)

### 4. Other Embodiments (Modification Examples)

### 1. First Embodiment

### Configuration Example of Photoelectric-Conversion Device

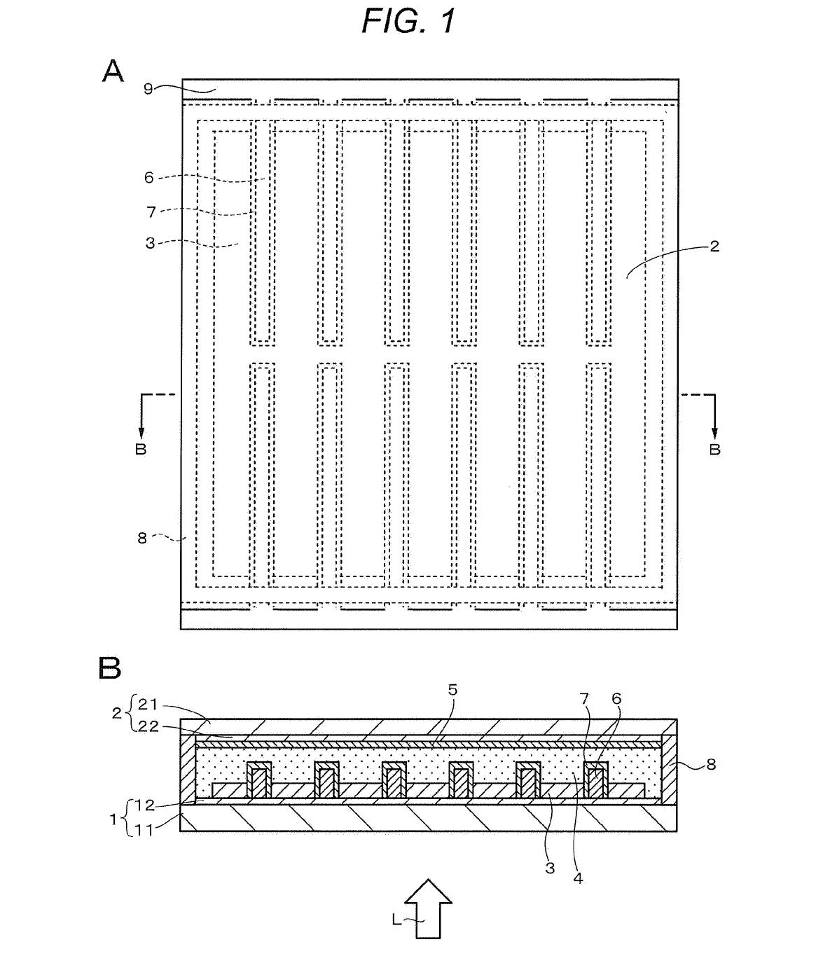

A configuration example of a photoelectric-conversion device according to a first embodiment of the present technique will be described. FIG. 1A is a plan view illustrating a configuration example of a photoelectric-conversion device according to the first embodiment of the present technique. FIG. 1B is a cross-sectional view of FIG. 1A along the line B-B. As shown in FIGS. 1A and 1B, this photoelectric-conversion device includes a conductive base material 1, a conductive base material 2, a porous semiconductor layer 3 carrying a dye, an electrolyte layer 4, a counter electrode 5, a current collector 6, a protective layer 7, a sealing material 8, and a current collector terminal 9.

The conductive base material 1 and the conductive base material 2 are placed to be opposed to each other. The conductive base material 1 has a principal surface opposed to the conductive base material 2, and the porous semiconductor layer 3 is formed on the principal surface. In addition, the conductive base material 1 has, on the principal surface thereof, the current collector 6 formed, and the protective layer 7 is formed on the surface of the current collector 6. The conductive base material 2 has a principal surface opposed to the conductive base material 1, and the counter electrode 5 is formed on the principal surface. The electrolyte layer 4 is interposed between the porous semiconductor layer 3 and the counter electrode 5 opposed to each other. The conductive base material 1 has another principal surface on the side opposite to the principal surface with the porous semiconductor layer 3 formed thereon, and for example, the other principal surface serves as a light-receiving surface for receiving light L such as sunlight.

The sealing material 8 is provided on outer edges of the opposed surfaces of the conductive base material 1 and conductive base material 2. The interval between the porous semiconductor layer 3 and the counter electrode 5 is preferably 1 to 100 μm, and more preferably 1 to 40 μm. The electrolyte layer 4 is encapsulated in the space enclosed by the conductive base material 1 with the porous semiconductor layer 3 formed thereon, the conductive base material 2 with the counter electrode 5 formed thereon, and the sealing material 8.

The conductive base materials 1, 2, the porous semiconductor layer 3, a sensitizing dye, the electrolyte layer 4, the counter electrode 5, the current collector 6, the protective layer 7, the sealing material 8, and the current collector terminal 9 will be sequentially described below, which constitute the photoelectric-conversion device.

### (Conductive Base Material)

The conductive base material 1, which is, for example, a transparent conductive base material, includes a base material 11 and a transparent conductive layer 12 formed on a principal surface of the base material 11, and the porous semiconductor layer 3 is formed on the transparent conductive layer 12. The conductive base material 2 includes a base material 21 and a transparent conductive layer 22 formed on a principal surface of the base material 21, and the counter electrode 5 is formed on the transparent conductive layer 22.

The base material 11 may be any base material as long as the material is transparent, and various base materials can be used. As the transparent base material which preferably absorbs less light in the visible to near-infrared region of sunlight, for example, glass base materials, resin base materials, and the like can be used, but the transparent base material is not to be limited to thereto. As the material for the glass base material, for example, quartz, blue plate, BK7, lead glass, and the like can be used, but the material is not to be limited thereto. As the resin base material, for example, polyethylene terephthalate (PET), polyethylene naphthalate (PEN), polyimide (PI), polyester, polyethylene (PE), polycarbonate (PC), polyvinyl butyrate, polypropylene (PP), tetra-acetyl cellulose, syndiotactic polystyrene, polyphenylenesulfide, polyarylate, polysulfone, polyestersulfone, polyetherimide, cyclic polyolefin, phenoxy bromide, vinyl chloride, and the like can be used, but the resin material is not to be limited thereto. As the base materials 11, 12, for example, films, sheets, substrates, and the like can be used, but the base materials are not to be limited thereto.

The base material 21 is not to be considered particularly limited to transparent base materials, but opaque base materials can be used, and for example, various base materials can be used such as opaque or transparent inorganic base materials or plastic base materials. As the materials for the inorganic base materials or plastic base materials, for example, the above materials exemplified as the material for the base material 11 can be used in the same way, and besides, it is also possible to use opaque base materials such as metal base materials. In the case of using, as the base material 21, a conductive base material such as a metal base material, the formation of the transparent conductive layer 22 may be skipped.

The transparent conductive layers 12, 22 preferably absorb less light in the visible to near-infrared region of sunlight. As the materials for the transparent conductive layers 12, 22, for example, metal oxide or carbon is preferably used which has favorable conductivity. As the metal oxide, one or more can be used which are selected from the group consisting of, for example, indium-tin composite oxide (ITO), fluorine-doped SnO₂ (FTO), antimony-doped SnO₂ (ATO), tin oxide (SnO₂), zinc oxide (ZnO), indium-zinc composite oxide (IZO), aluminum-zinc composite oxide (AZO), and gallium-zinc composite oxide (GZO). Layers for the purpose of promoting adhesion, improving electron transfer, or preventing a reverse electron process may be further provided between the transparent conductive layer 22 and the porous semiconductor layer 3.

### (Porous Semiconductor Layer)

The porous semiconductor layer 3 is preferably a porous layer containing metal oxide semiconductor microparticles. The metal oxide semiconductor microparticles preferably contain a metal oxide containing at least one of titanium, zinc, tin, and niobium. This is because when this metal oxide is contained therein, an appropriate energy band is formed between the dye to be adsorbed and the metal oxide, and thereafter, electrons generated in the dye by light irradiation can be smoothly transferred to the metal oxide to make a contribution to subsequent power generation by redox of iodine. Specifically, as the material for metal oxide semiconductor microparticles, one or more can be used which are selected from the group consisting of titanium oxide, tin oxide, tungsten oxide, zinc oxide, indium oxide, niobium oxide, iron oxide, nickel oxide, cobalt oxide, strontium oxide, tantalum oxide, antimony oxide, lanthanoid oxide, yttrium oxide, vanadium oxide, and the like, but the material is not to be considered limited thereto. In order to sensitize the surface of the porous semiconductor layer with the sensitizing dye, the conduction band of the porous semiconductor layer 3 is preferably present in a position that is likely to receive electrons from the light excitation level of the sensitizing dye. From this perspective, among the above-mentioned materials for the metal oxide semiconductor microparticles, one or more materials are particularly preferred which are selected from the group consisting of titanium oxide, zinc oxide, tin oxide, and niobium oxide. Moreover, titanium oxide is most preferred from the perspective of price, environmental health, etc. The metal oxide semiconductor microparticles particularly preferably contains a titanium oxide that has an anatase-type or brookite-type crystal structure. This is because when this titanium oxide is contained therein, an appropriate energy band is formed between the dye to be adsorbed and the metal oxide, and thereafter, electrons generated in the dye by light irradiation can be smoothly transferred to the metal oxide to make a contribution to subsequent power generation by redox of iodine. The metal oxide semiconductor microparticles preferably have an average primary particle size of 5 nm or more and 500 nm or less. The average primary particle size less than 5 nm has a tendency to extremely degrade the crystallinity, and fail to maintain the anatase structure, thereby resulting in an amorphous structure. On the other hand, the average primary particle size greater than 500 nm has a tendency to significantly reduce the specific surface area, thereby decreasing the total amount of the dye to be adsorbed onto the porous semiconductor layer 3 for making a contribution to power generation. The average primary particle size herein is obtained by a method of measuring through a light scattering method with the use of a dilute solution subjected to a dispersion treatment down to primary particles through the addition of a desired dispersant with the use of a solvent system in which the primary particles can be dispersed.

The porous semiconductor layer 3 includes a coadsorbent and a dye. The coadsorbent and the dye are preferably adsorbed onto the porous semiconductor layer 3. When the porous semiconductor layer 3 has metal oxide semiconductor microparticles, the coadsorbent and the dye are preferably adsorbed onto the surface of the metal oxide semiconductor microparticles.

### (Coadsorbent)

Examples of the coadsorbent specifically include, for example, decylphosphonic acids (DPA) represented by the formula (1). Besides, even such compounds having a somewhat increased or decreased number of carbon atoms in relation to the linear alkyl group of the decylphosphonic acid, such as octylphosphonic acids (OPA), have a tendency to achieve similar effects. Therefore, the coadsorbent may be, for example, a phosphorous compound represented by the general formula (A).

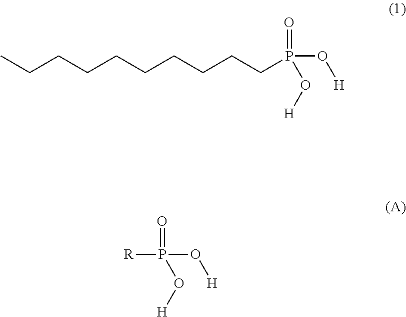

(In the formula, R is a linear alkyl group having 8 to 16 carbon atoms, preferably a linear alkyl group having 8 to 14 carbon atoms, and more preferably a linear alkyl group having 8 to 12 carbon atoms.)

### (Dye)

As the dye, a ruthenium complex dye is preferably used. As the ruthenium complex dye, for example, a ruthenium-bipyridine complex dye, a ruthenium-terpyridine complex dye, a ruthenium phenanthroline complex dye, a quinoline-based ruthenium complex dye, and a β-diketone-ruthenium complex dye can be used singularly, or two or more of the dyes can be used in combination. Specifically, examples of the ruthenium complex dye include ruthenium-bipyridine complex dyes such as Z907 [cis-bis(thiocyanate)(4,4′-dinonyl-2,2′-bipyridine)(4,4′-dicarboxyl-2,2′-bipyridine) ruthenium(II) complex] represented by the formula (2), Z991 [cis-bis(thiocyanate){4,4′-(5′-octyl[2,2′ bithiophene]-5-yl)-2,2′-bipyridine}(4,4′-dicarboxyl-2,2′-bipyridine) ruthenium (II) complex] represented by the formula (3), N719 [cis-bis(thiocyanate)bis(4,4′-dicarboxylate-2,2′-bipyridine) ruthenium(II)di-tetrabutylammonium complex], and N3 [cis-bis(thiocyanate)bis(4,4′-dicarboxylate-2,2′-bipyridine) ruthenium (II) complex]; and ruthenium-terpyridine complex dyes such as a black dye [tris(thiocyanate)(4,4′,4″-tricarboxylate-2,2′:6′,2″-terpyridine) ruthenium (II)tri-tetrabutylammonium complex]. One of these dyes, or two or more thereof may be used.

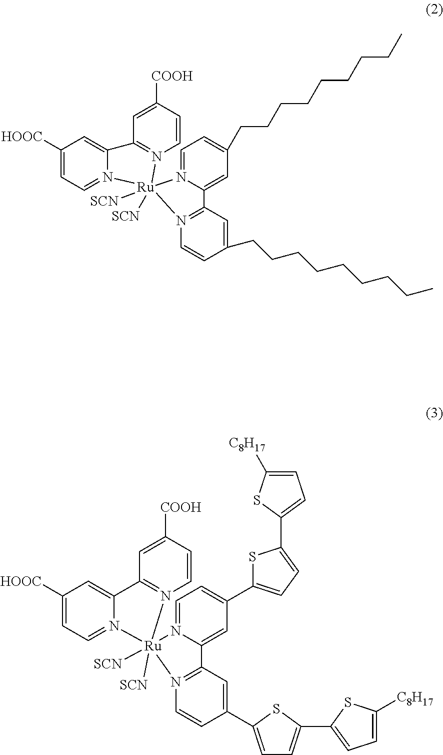

### (Molar Ratio (Coadsorbent/Dye))

The molar ratio of the adsorbed amount of the coadsorbent to the adsorbed amount of the dye, adsorbed on the porous semiconductor layer 3 (hereinafter, appropriately abbreviated as the molar ratio (coadsorbent/dye)) is preferably 0.5 or more, more preferably 0.8 or more, further preferably 0.8 or more and 3.0 or less, and particularly preferably 0.8 or more and 2.0 or less. The lower limit of the molar ratio (coadsorbent/dye) is set to 0.5, because the molar ratio (coadsorbent/dye) of 0.5 or more can suppress dye desorption and dye aggregation, and suppress long-term performance degradation. As for the upper limit of the molar ratio (coadsorbent/dye), while the long-term performance degradation can be further suppressed with the increase in molar ratio, the upper limit of the molar ratio (coadsorbent/dye) is preferably 3.0, and more preferably 2.0, in consideration of initial photoelectric conversion efficiency in addition to the ability to suppress the long-term performance degradation.

The molar ratio (coadsorbent/dye) can be obtained, for example, in such a way that the dye and coadsorbent adsorbed on the porous semiconductor layer 3 are decomposed by pressurized acid decomposition or the like, and quantitative analysis of Ru in the ruthenium complex dye and P in the coadsorbent is performed by ICP-AES (ICP-Atomic Emission Spectrometry).

### (Function Effect of Coadsorbent)

The present technique makes it possible to suppress dye desorption, dye aggregation, etc., and suppress long-term performance degradation, when the coadsorbent and the ruthenium complex dye are adsorbed onto the porous semiconductor layer 3 at a predetermined molar ratio (molar ratio (coadsorbent/dye) of 0.5 or more). This effect is presumed to be achieved, for example, by the mechanism described below.

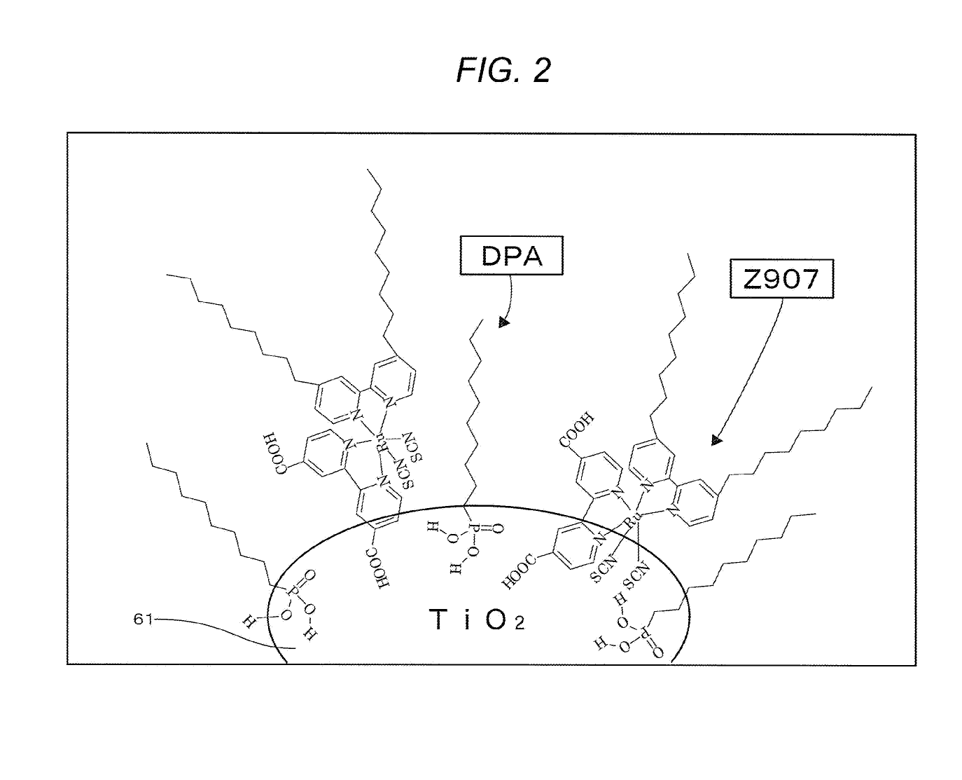

FIG. 2 is a pattern diagram illustrating a decylphosphonic acid (DPA) as the coadsorbent and a ruthenium complex dye (Z907) which are desorbed on a porous titanium oxide layer as the porous semiconductor layer 3. At a predetermined molar ratio, the decylphosphonic acid (DPA) as the coadsorbent and the ruthenium complex dye (Z907) are both considered adsorbed on the surface of a TiO₂ microparticle 61 to suppress dye desorption.

In addition, as shown in FIG. 2, the decylphosphonic acid (DPA) as the coadsorbent interposed between the ruthenium complex dyes (Z907) is considered to suppress aggregation of the ruthenium complex dyes (Z907), thereby making it possible to suppress the interaction between the dyes for the generation of a dye that makes no contribution to power generation. In addition, the DPA is considered to have a phosphonic group adsorbed on the surface of the TiO₂ microparticle 61, thereby making a long-chain alkyl group extending from the surface of the TiO₂ microparticle 61. Thus, the surface of the TiO₂ microparticle 61 in the hydrophobic atmosphere is considered to be able to suppress desorption of the dye from the surface of the TiO₂ microparticle 61, even when there is a minute amount of moisture in the electrolyte solution.

In addition, the decylphosphonic acid (DPA) as the coadsorbent, and the like are considered to adsorb onto the surface of the TiO₂ microparticle 61 to decrease the surface area of the TiO₂, thereby making it possible to suppress reverse electron transfer.

In Patent Document 1 (JP 2006-525632 W) mentioned in the BACKGROUND ART, incidentally, a decylphosphonic acid (coadsorbent) is added to a dye solution to adsorb the decylphosphonic acid along with the dye onto a porous semiconductor layer. Patent Document 1 discloses the numerical range of the specific molar ratio between the coadsorbent and dye in the dye solution used for dye adsorption in the cell manufacturing process. However, Patent Document 1 fails to disclose the numerical range of the molar ratio between the dye and coadsorbent adsorbed on the porous semiconductor layer 3 as in the present technique, and focuses no attention at all on association between the numerical range of the molar ratio and the effect of suppressing long-term performance degradation.

In addition, even when the concentrations of the coadsorbent and dye in the dye solution used for dye adsorption are fixed in the cell manufacturing process as described in Patent Document 1, the adsorbed amount of the dye per unit area will vary significantly with the change in the surface area of the porous titanium oxide layer. Therefore, in order to achieve the effect of suppressing long-term performance degradation, there is a need to define the range of the molar ratio between the dye and coadsorbent adsorbed on the porous semiconductor layer 3 as in the present technique.

The film thickness of the porous semiconductor layer 3 is preferably 0.5 μm or more and 200 μm or less. The film thickness less than 0.5 μm has a tendency to fail to achieve an effective conversion efficiency. On the other hand, the film thickness greater than 200 μm has a tendency to make the manufacture difficult, such as cracking or peeling caused during the film formation. In addition, the thickness has a tendency to make a favorable conversion efficiency less likely to be achieved, because generated electric charges are not effectively transferred to the transparent conductive layer 12, due to the increased distance between the surface of the porous semiconductor layer 3 on the electrolyte layer side and the surface of the transparent conductive layer 12 on the porous semiconductor layer side.

### (Counter Electrode)

The counter electrode 5 is intended to function as the positive electrode of the photoelectric-conversion device (photoelectric-conversion cell). Examples of the conductive material used for the counter electrode 5 include, but not limited to, for example, a metals, a metal oxide, or carbon. As the metal, for example, platinum, gold, silver, copper, aluminum, rhodium, indium, etc. can be used, but the metal is not to be considered limited thereto. As the metal oxide, for example, ITO (indium-tin oxide), tin oxide (including those doped with fluorine or the like), zinc oxide, etc. can be used, but the metal oxide is not to be considered limited thereto. The film thickness of the counter electrode 5 is not particularly limited, but preferably 5 nm or more and 100 μm or less.

### (Electrolyte Layer)

The electrolyte layer 4 is preferably composed of an electrolyte, a medium, and an additive. The electrolyte is a mixture of I₂ with an iodide (e.g., LiI, NaI, KI, CsI, MgI₂, CaI₂, CuI, tetraalkylammonium iodide, pyridinium iodide, imidazolium iodide, etc.), or a mixture of Br₂ with a bromide (e.g., LiBr, etc.), and among these mixtures, preferably a mixture with LiI, pyridinium iodide, imidazolium iodide, or the like as the combination of I₂ with an iodide, but not to be considered limited to this combination.

The concentration of the electrolyte with respect to the medium is preferably 0.05 to 10 M, more preferably 0.05 to 5 M, and further preferably 0.2 to 3 M. The concentration of I₂ or Br₂ is preferably 0.0005 to 1 M, more preferably 0.001 to 0.5 M, and further preferably 0.001 to 0.3 M. In addition, for the purpose of improving the open voltage of the photoelectric-conversion device, various types of additives can be also added, such as 4-tert-butylpyridine and benzimidazoliums.

The medium used for the electrolyte layer 4 is preferably a compound that can exhibit favorable ion conductivity. As the medium in solution, media can be used, such as, for example, ether compounds, e.g., dioxane and diethyl ether; linear ethers, e.g., ethylene glycol dialkyl ether, propylene glycol dialkyl ether, polyethylene glycol dialkyl ether, and polypropylene glycol dialkyl ether; alcohols, e.g., methanol, ethanol, ethylene glycol monoalkyl ether, propylene glycol monoalkyl ether, polyethylene glycol monoalkyl ether, and polypropylene glycol monoalkyl ether; polyalcohols, e.g., ethylene glycol, propylene glycol, polyethylene glycol, polypropylene glycol, and glycerin; nitrile compounds, e.g., acetonitrile, glutarodinitrile, methoxyacetonitrile, propionitrile, and benzonitrile; carbonate compounds, e.g., ethylene carbonate and propylene carbonate; heterocyclic compounds, e.g., 3-methyl-2-oxazolidinone; and aprotic polar substances, e.g., dimethylsulfoxide and sulfolane.

In addition, for the purpose of using a solid (including gel states) medium, a polymer may be contained. In this case, the medium is made into a solid state by polymerizing a multifunctional monomer having an ethylenically unsaturated group in the medium in solution, through the addition of a polymer such as polyacrylonitrile or polyvinylidene fluoride into the medium in solution.

As the electrolyte layer 4, besides, hole transporting materials can be used such as CuI, electrolytes requiring no CuSCN medium, and 2,2′,7,7′-tetrakis(N,N-di-p-methoxyphenylamine)9,9′-spirobifluorene.

### (Current Collector, Current Collector Terminal)

The current collector 6 and the current collector terminal 9 are formed from a material that is lower in electrical resistance than the transparent conductive layer 22. The current collector 6 is, for example, a current collecting wiring material formed in a predetermined shape on one principal surface of the conductive base material 1. Examples of the shape of the current collecting wiring include, but not limited to, for example, a striped shape and a grid-like shape. Examples of the material constituting the current collector 6 and the current collector terminal 9 can include gold (Au), silver (Ag), aluminum (Al), copper (Cu), platinum (Pt), titanium (Ti), nickel (Ni), iron (Fe), zinc (Zn), molybdenum (Mo), tungsten (W), and chromium (Cr), or compounds and alloys of these metals, and solder. If necessary, the current collector 6 may be entirely or partially from a conductive adhesive, a conductive rubber, an anisotropic conductive adhesive.

### (Protective Layer)

The protective layer 7 may be composed of a material that has corrosion resistance to the electrolyte (for example, iodine) constituting the electrolyte solution or the like, and the provision of the protective layer 7 keeps the current collector 6 from coming into contact with the electrolyte layer 4, and thereby can prevent any reverse electron transfer reaction and corrosion of the current collector 6. Examples of the material constituting the current collector 6 can include, for example, metal oxides; metal nitrides such as TiN and WN; glass such as low-melting-point glass frit; and various types of resins such as epoxy resins, silicone resins, polyimide resins, acrylic resins, polyisobutylene resins, ionomer resins, and polyolefin resins.

### (Sealing Material)

The sealing material 8 is intended to prevent any leakage and volatilization of the electrolyte layer 4 and any ingress of impurities from the outside. As the sealing material 8, a resin is preferably used which has resistance to the material constituting the electrolyte layer 4, for example, thermal fusion films, thermosetting resins, ultraviolet curable resins, ceramics, and the like can be used, and more specifically, epoxy resins, acrylic adhesives, EVA (ethylene vinyl acetate), ionomer resins, and the like can be used.

### [Method for Manufacturing Photoelectric-Conversion Device]

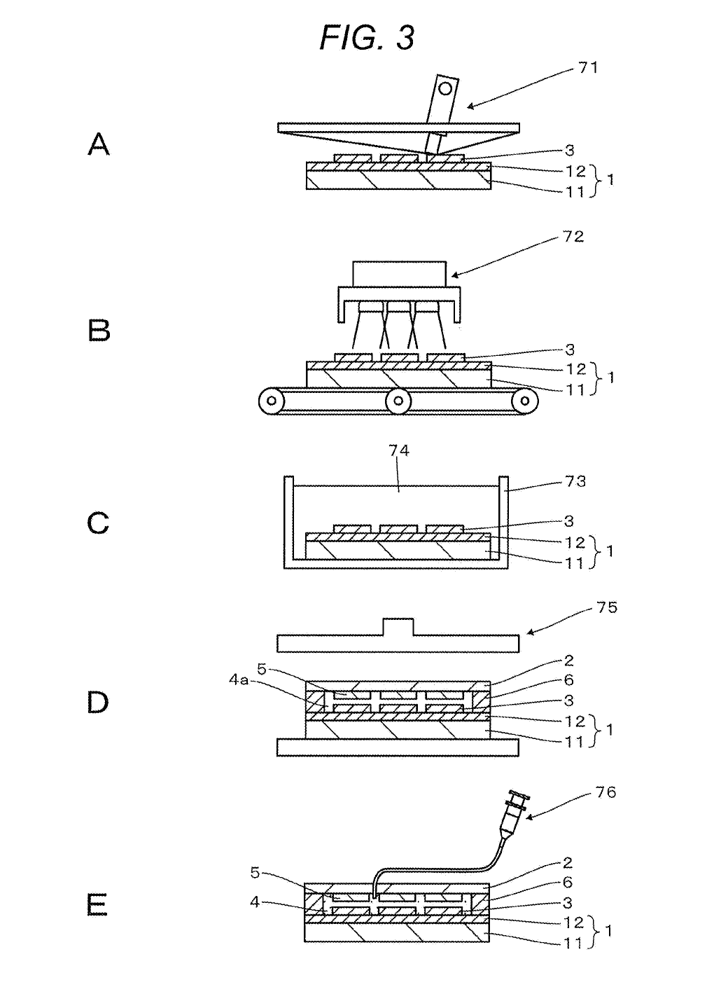

Next, an example of a method for manufacturing a photoelectric-conversion device according to an embodiment of the present technique will be described. In the following description, an explanation will be given appropriately with reference to the cross-sectional views shown in FIGS. 3A to 3E.

### (Formation of Transparent Conductive Base Material)

First, base material 11 is prepared in the form of a plate or a film. Next, the transparent conductive layer 12 is formed on the base material 11 by a thin-film preparation technique such as a sputtering method. Thus, the conductive base material 1 is obtained.

### (Formation of Current Collector)

Next, for example, the current collector 6 is formed on the transparent conductive layer 12. For example, a conductive paste such as an Ag paste is applied onto the transparent conductive layer 12 by a screen printing method or the like, and if necessary, subjected to drying and firing to form the current collector 6 composed of silver or the like. It is to be noted that the illustration of the current collector 6 is omitted in FIGS. 3A through 3E.

### (Formation of Protective Layer)

Next, in order to shield the current collector 6 from the electrolyte solution for protection, the protective layer 7 is formed on the surface of the current collector 6. Specifically, for example, an epoxy resin or the like is applied by a screen printing method or the like, cured to form the protective layer 7 on the surface of the current collector 6. For example, when a resin material is used such as an epoxy resin, the epoxy resin is subjected to sufficient leveling, and then completely cured with the use of an UV spot irradiation machine. It is to be noted that the illustration of the protective layer 7 is omitted in FIGS. 3A through 3E.

### (Formation of Porous Semiconductor Layer)

Next, the porous semiconductor layer 3 is formed on the transparent conductive layer 12 of the conductive base material 1. Details on the step of forming the porous semiconductor layer 3 will be described below.

First, metal oxide semiconductor microparticles are dispersed in a solvent to prepare a paste as a composition for the formation of a porous semiconductor layer. If necessary, a binder may be further dispersed in the solvent. In the paste preparation, if necessary, monodisperse colloid particles may be utilized which are obtained from hydrothermal synthesis. As the solvent, lower alcohols having 4 or less carbon atoms, such as methanol, ethanol, isopropanol, n-butanol, sec-butanol, t-butanol; aliphatic glycols such as ethylene glycol, propylene glycol(1,3-propanediol), 1,3-propanediol, 1,4-butanediol, 1,2-butanediol, 1,3-butanediol, and 2-methyl-1,3-propanediol; ketones such as methyl ethyl ketone; and amines such as dimethylethylamine can be used singularly, or two or more thereof can be used in combination, but the solvent is not to be considered particularly limited thereto. As the dispersion method, for example, known methods can be used, and specifically, for example, an agitation treatment, an ultrasonic dispersion treatment, a beads dispersion treatment, a kneading treatment, a homogenizer treatment, and the like can be used, but the dispersion method is not to be considered particularly limited thereto.

Next, as shown in FIG. 3A, the prepared paste is applied or printed onto the transparent conductive layer 12 by a screen printing method with the use of a screen printer 71. Next, the paste applied or printed onto the transparent conductive layer 12 is dried to volatilize the solvent. Thus, the porous semiconductor layer 3 is formed on the transparent conductive layer 12. The drying condition is not to be considered particularly limited, which may be natural drying, or artificial drying with the drying temperature or drying time adjusted. In the case of artificial drying, the drying temperature and the drying time are preferably set without altering the base material 11, in consideration of the heat resistance of the base material 11. It is to be noted that applying or printing method is not to be considered limited to the screen printing method, and it is preferable to use a simple method suitable for mass productivity. As the applying method, for example, a micro gravure coating method, a wire barcode method, a direct gravure coating method, a die coating method, a dip method, a spray coating method, a reverse roll coating method, a curtain coating method, a comma coating method, a knife coating method, a spin coating method, and the like can be used, but the applying method is not to be considered particularly limited thereto. In addition, as the printing method, a letterpress printing method, an offset printing, a gravure printing method, an intaglio printing method, a rubber plate printing method, and the like can be used, but the printing method is not to be considered particularly limited thereto.

### (Firing)

Next, as shown in FIG. 3B, the porous semiconductor layer 3 prepared in the way described above is subjected to firing with, for example, a conveyer electric furnace 72 to improve electronic connections between metal oxide semiconductor microparticles in the porous semiconductor layer 3. The firing temperature is preferably 40 to 1000° C., and more preferably on the order of 40 to 600° C., but not to be considered particularly limited to this temperature range. In addition, the firing time is preferably on the order of 30 seconds to 10 hours, but not to be considered particularly limited to this time range. In this stage, the binder component is removed.

### (Dye Support)

Next, as shown in FIG. 3C, the conductive base material 1 with the porous semiconductor layer 3 formed is immersed in a dye solution accumulated in a liquid tank 73 as an immersion liquid 74, resulting in the dye and coadsorbent adsorbed onto the metal oxide microparticles included in the porous semiconductor layer 3.

The dye solution is prepared, for example, as follows. More specifically, first, the dye and the coadsorbent are dissolved in a solvent to prepare a solution. In order to dissolve the dye and the coadsorbent, if necessary, heating may be carried out, a dissolving aid may be added, and insoluble filtration may be carried out. The solvent is preferably able to dissolve the dye and the coadsorbent, and serve as a mediator for dye adsorption onto the porous semiconductor layer 3, and for example, alcohol solvents such as ethanol, isopropyl alcohol, and benzyl alcohol; nitrile solvents such as acetonitrile and propionitrile; halogen solvent such as chloroform, dichloromethane, and chlorobenzene; ether solvents such as diethyl ether and tetrahydrofurane; ester solvents such as ethyl acetate and butyl acetate; ketone solvents such as acetone, methyl ethyl ketone, and cyclohexanone; carbonate solvents such as diethyl carbonate and propylene carbonate; carbohydrate solvents such as hexane, octane, toluene, and xylene; dimethylformamide, dimethylacetoamide, dimethylsulfoxide, 1,3-dimethyl imidazolinone, N methylpyrrolidon, and water can be used singularly, or two or more thereof can be mixed and used, but the solvent is not to be considered limited thereto.

On the other hand, the conductive base material 2 is prepared, and the counter electrode 5 is formed. Examples of the method for forming the counter electrode 5 include, for example, wet methods such as an application method; and dry methods such as physical vapor deposition methods such as a sputtering method and a vapor deposition method, and various types of chemical vapor deposition (CVD) methods.

Next, as shown in FIG. 3D, the sealing material 8 is provided on an outer edge of the transparent conductive layer 22 of the conductive base material 2 with the counter electrode 5 formed, and the conductive base material 1 is then attached thereto with the sealing material 8 interposed therebetween. Thus, the conductive base material 1, the conductive base material 2, and the sealing material 8 form a space 4a to be filled with the electrolyte layer 4. In this case, the porous semiconductor layer 3 and the counter electrode 5 are placed to be opposed at a predetermined interval, for example, an interval of 1 to 100 μm, preferably 1 to 50 μm. In addition, when the conductive base material 1 and the conductive base material 2 are attached to each other, a pressure may be applied to the conductive base material 1 and/or the conductive base material 2 with the use of a pressing machine 75.

Next, as shown in FIG. 3E, an electrolyte solution is injected into the space 4a, for example, from an inlet formed in advance in the conductive base material 2 with the use of an injector 76 to fill the space with the electrolyte solution as the electrolyte layer 4. Thereafter, the inlet is sealed with an ultraviolet curable resin. Thus, an intended photoelectric-conversion device is manufactured.

### 2. Second Embodiment

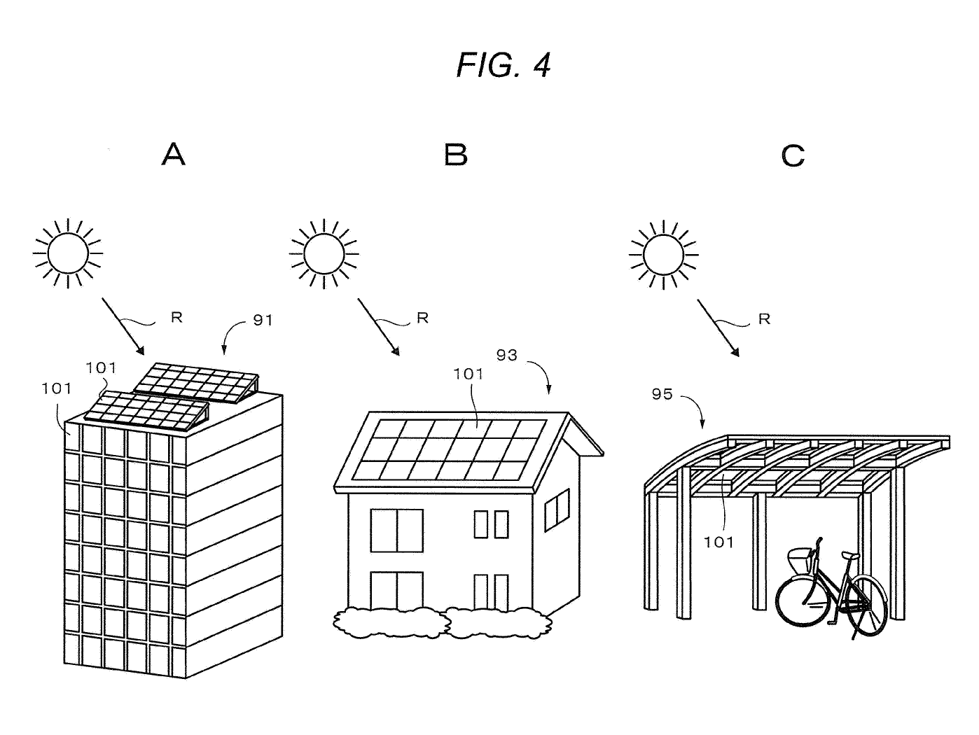

FIGS. 4A to 4C are diagrams illustrating examples of a building according to the present technique. Examples of the building can typically include, but not limited thereto, large buildings such as, for example, buildings and condominium apartment buildings, and the building may be basically any building as long as the building is a built structure with an outer wall surface. Examples of the building specifically include, for example, detached houses, apartment houses, post-houses, school buildings, government buildings, stadiums, baseball fields, hospitals, churches, factories, warehouses, huts, garages, bridges, and stores. A photoelectric-conversion module 101 has, for example, a plurality of photoelectric-conversion devices electrically connected. For example, the photoelectric-conversion device according to the first embodiment can be used as the photoelectric-conversion devices. The form of the plurality of photoelectric-conversion devices constituting the photoelectric-conversion module 101 is not to be considered particularly limited, and the plurality of photoelectric-conversion devices may be formed on individual substrates or one substrate, or each predetermined number of photoelectric-conversion devices may be formed on one substrate. In addition, the plurality of photoelectric-conversion devices may be divided into a predetermined number of blocks, and may be formed on individual substrates for each block.

FIG. 4A is a diagram illustrating an example of a building with the photoelectric-conversion module 101 placed. As shown in FIG. 4A, on the rooftop of the building 91, the photoelectric-conversion module 101 is placed horizontally or at a tilt, for example, from southeast to southwest (when the building 91 is built on the northern hemisphere). This is because the photoelectric-conversion module 101 placed in this orientation can receive sunlight R more effectively.

As shown in FIG. 4A, the photoelectric-conversion module 101 may be provided in a lighting section such as a window. When the photoelectric-conversion module 101 is provided in a window, a lighting section, or the like, the photoelectric-conversion module 101 is preferably placed between two transparent base materials. Examples of the transparent base materials can include, for example, glass plates. In this case, in order to prevent the photoelectric-conversion module 101 from moving within the photoelectric-conversion module 101, if necessary, the photoelectric-conversion module 101 is preferably fixed on one of the two base materials.

The photoelectric-conversion module 101 has an electrical connection to, for example, a power system in the building. Power obtained by the photoelectric-conversion module 101 is, for example, supplied as power for use in the building, such as lighting and air conditioning, or transmitted externally for selling the power. If necessary, the power may be stored in an electric storage device. When the building is a structure such as, for example, a bridge, a socket or the like for output is preferably provided for externally extracting power obtained by the photoelectric-conversion module 101. This is because the power obtained by the photoelectric-conversion module 101 can be utilized for charging mobile instruments, or as a power supply for emergency use at the time of disaster or the like.

FIG. 4B is a diagram illustrating an example of a house with the photoelectric-conversion module 101 placed. As shown in FIG. 4B, the photoelectric-conversion module 101 is placed horizontally or at a tilt on the roof of the house 93.

FIG. 4C is a diagram illustrating an example of a weather protection including the photoelectric-conversion module 101, which is placed in a bicycle parking area. As shown in FIG. 4C, the weather protection 95 placed in the bicycle parking area is provided with, for example, the photoelectric-conversion module 101. The weather protection 95 may have the function of a charging stand for motorized bicycles and the like.

Besides, examples of the building include, for example, sound abatement shields placed along with roads, railroad tracks, etc., and roofs of arcades. The building is particularly preferably a built structure including at least one lighting section. The present technique can be also applied to structures for shade, which are referred to as artificial trees for shade.

### 3. Third Embodiment

Examples of an electronic instrument according to the present technique will be described. The electronic instrument, which may be basically any electronic instrument, includes both mobile and stationary electronic instruments, and specific examples thereof include cellular phones, mobile instruments, robots, personal computers, in-car instruments, and various types of home electric appliances. These electronic instruments are provided with a photoelectric-conversion device as a power supply. This photoelectric-conversion device is, for example, a solar cell for use as a power supply for these electronic instruments. For example, the photoelectric-conversion device according to the first embodiment can be used as the photoelectric-conversion device.

### EXAMPLES

### Example 1-1

### Preparation of Photoelectric-Conversion Device

First, the transparent conductive layer 12 composed of a FTO layer formed on a glass substrate as the base material 11 was used as the conductive base material 1.

Next, a porous titanium oxide layer as the porous semiconductor layer 3 was formed on the transparent conductive layer 12. Specifically, a titanium oxide paste was prepared, which was applied onto the transparent conductive layer 12 to obtain the porous titanium oxide layer. Then, the porous titanium oxide layer was subjected to firing in an electric furnace at 510° C. for 30 minutes, and left for cooling. Next, the current collector 6 and current collector terminal 9 composed of Ag were formed on the transparent conductive layer 12. Specifically, a silver paste was applied by a screen printing method onto the transparent conductive layer 12 to obtain the current collector 6 and current collector terminal 9 shaped as shown in FIG. 1A. Then, the applied silver paste was sufficiently dried, and then subjected to firing in an electric furnace at 510° C. for 30 minutes. Next, in order to shield the current collector 6 from the electrolyte solution for protection, the protective layer 7 was formed on the surface of the current collector 6. Specifically, for the formation of the protective layer 7, an epoxy resin was applied by a screen printing method to form the protective layer 7. The epoxy liquid resin was subjected to sufficient leveling, and the epoxy resin was then completely cured with the use of an UV spot irradiation machine.

### (Dye Adsorption by Immersion Method)

A dye was adsorbed by an immersion method onto the porous titanium oxide layer. More specifically, as the dye solution, a ruthenium complex dye (Z907) and a decylphosphonic acid (hereinafter, abbreviated as a DPA) were dissolved in a mixed liquid of acetonitrile/tert-butyl alcohol to prepare a dye solution, and the dye was desorbed onto the porous semiconductor layer 3 by immersion in the dye solution.

On the other hand, a glass plate was used as the base material 21, and on the base material 21, a Pt layer was formed as the counter electrode 5. Specifically, on the glass plate, the Pt layer was formed by sputtering.

Next, a predetermined position of the base material 21 was irradiated with a YAG laser to provide an inlet. Thereafter, the sealing material 8 was formed. Next, the electrolyte solution was prepared. This electrolyte solution was prepared as follows. In 5.0 g of methoxypropionitrile, 1.1 g of 1-methyl-3-propylimidazoliumiodide, 0.1 g of iodine, and 0.2 g of 1-butylbenzimidazole were dissolved to prepare the electrolyte solution.

Next, the electrolyte solution was injected from the inlet provided in the base material 21, and then held for a predetermined period of time to achieve complete penetration of the electrolyte solution between the conductive base material 1 and the base material 21 with the Pt layer formed. Thereafter, the electrolyte solution around the inlet was completely removed, and the inlet was sealed with an ultraviolet curable resin. As described above, a photoelectric-conversion device was prepared.

### (Measurement of Molar Ratio Between Dye and Coadsorbent)

The porous titanium oxide layer with the dye was peeled from the glass substrate, and used as a measurement sample. The dye and coadsorbent adsorbed on the measurement sample were decomposed by pressurized acid decomposition, and quantitative analysis of Ru and P was performed by ICP-AES. This quantitative analysis figured out the amounts of the dye and coadsorbent per unit volume, which were adsorbed on the porous titanium oxide layer.

As a result, the molar ratio between the Z907 and DPA adsorbed on the porous titanium oxide layer was Z907: DPA=1:0.8. More specifically, the molar ratio of the adsorbed amount of DPA to the adsorbed amount of Z907 was 0.8.

### Example 1-2

Except that the ratio between the adsorbed amounts of the dye and coadsorbent adsorbed on the porous titanium oxide layer was changed by appropriately adjusting, for dye adsorption, the concentration of the dye solution and the time of immersion in the dye solution, a photoelectric-conversion device was prepared in the same way as in Example 1-1. In addition, the amounts of the dye and coadsorbent adsorbed on the porous titanium oxide layer were figured out in the same way as in Example 1-1. As a result, the molar ratio between the Z907 and DPA adsorbed on the porous titanium oxide layer was Z907: DPA=1:1.5. More specifically, the molar ratio of the adsorbed amount of DPA to the adsorbed amount of Z907 was 1.5.

### Example 1-3

Except that the ratio between the adsorbed amounts of the dye and coadsorbent adsorbed on the porous titanium oxide layer was changed by appropriately adjusting, for dye adsorption, the concentration of the dye solution and the time of immersion in the dye solution, a photoelectric-conversion device was prepared in the same way as in Example 1-1. In addition, the amounts of the dye and coadsorbent adsorbed on the porous titanium oxide layer were figured out in the same way as in Example 1-1. As a result, the molar ratio between the Z907 and DPA adsorbed on the porous titanium oxide layer was Z907: DPA=1:2.0. More specifically, the molar ratio of the adsorbed amount of DPA to the adsorbed amount of Z907 was 2.0. In addition, the adsorbed amounts per unit volume onto the porous titanium oxide layer were Z907:1.23 μmol/cm³ and DPA: 2.46 μmol/cm³.

### Comparative Example 1

Except that the dye solution for dye adsorption was made to contain no DPA, a photoelectric-conversion device was prepared in the same way as in Example 1-1.

The following tests were carried out for each of the multiple photoelectric-conversion devices prepared.

### (Dark Storage Test at 85° C.)

In accordance with the JIS standard for amorphous silicon (JIS C 8983 Environmental Testing Procedure and Durability Testing Procedure for Amorphous Solar Cell Module), an accelerated test was carried out for evaluating long-term performance. More specifically, the photoelectric-conversion device was placed for 1000±12 hours under an environment maintained at 85° C.±2° C., and the rate of performance degradation was confirmed subsequently.

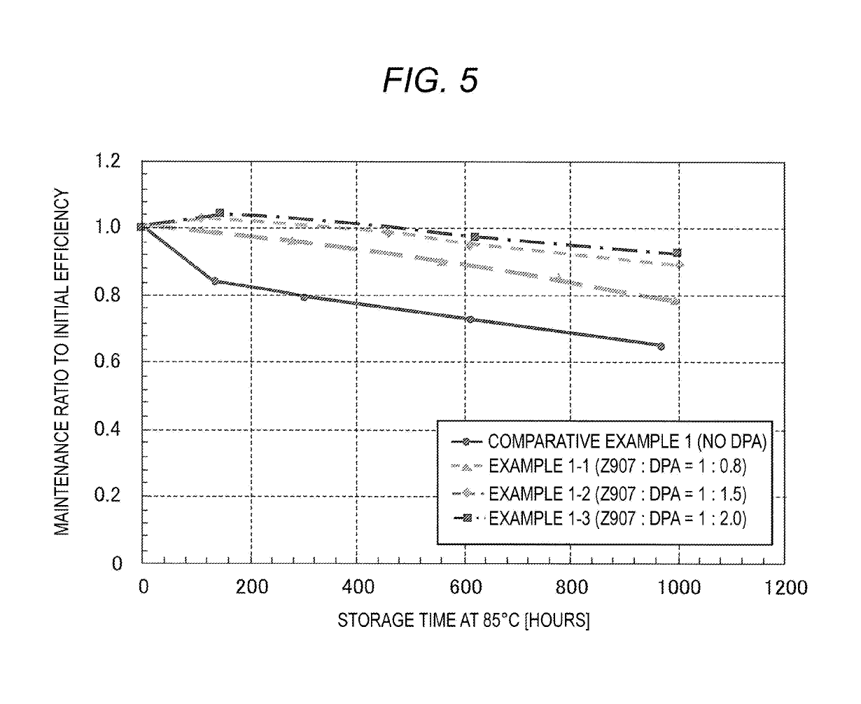

A graph of the measurement results plotted was created with the storage time at 85° C. as the horizontal axis and the maintenance ratio to the initial efficiency as a vertical axis. FIG. 5 shows the graph of the measurement results plotted.

As shown in FIG. 5, in Comparative Example 1, the initial performance declined down to on the order of 60% thereof after 100 hours in the accelerated test at 85° C. for the cell, because of no DPA adsorbed on the porous titanium oxide layer. In contrast, Examples 1-1 to 1-3 have improved performance maintenance ratios after 1000 hours at 85° C., because the molar ratio of the adsorbed amount of DPA to the adsorbed amount of Z907 is 0.8 or more with respect to the porous titanium oxide layer. Example 1-1 has succeeded in confirming an improvement up to 80%, when the molar ratio between Z907 and DPA adsorbed on the porous titanium oxide layer (Z907: DPA) is 1:0.8. Example 1-3 has succeeded in confirming an improvement up to on the order of 90% of the initial performance, when the molar ratio between Z907 and DPA adsorbed on the porous titanium oxide layer (Z907: DPA) is 1:2.0.

### Test Example 1

In addition, the dye concentration of the dye solution and the time of immersion in the dye solution were appropriately adjusted to prepare multiple photoelectric-conversion devices with varied adsorbed amounts of ruthenium-based dye (Z907) and DPA adsorbed on the porous titanium oxide layer.

The following measurements were carried out for each of the multiple photoelectric-conversion devices.

### (Molar Ratio of Adsorbed Amount of DPA to Adsorbed Amount of Z907)

As described above, quantitative analysis of Ru and P was performed by ICP-AES. This quantitative analysis figured out the molar ratio of the adsorbed amount of DPA to the adsorbed amount of Z907 per unit volume, adsorbed on the porous titanium oxide layer.

### (Measurement of Initial Efficiency)

The I-V measurement in the case of pseudo-sunlight (AM 1.5 G, 100 mW/cm²) irradiation with the use of a solar simulator was carried out to measure the initial photoelectric conversion efficiency.

### (Dark Storage Test at 85° C.)

In accordance with the JIS standard for amorphous silicon (JIS C 8983 Environmental Testing Procedure and Durability Testing Procedure for Amorphous Solar Cell Module), an accelerated test was carried out for evaluating long-term performance. More specifically, the photoelectric-conversion device was placed for 1000±12 hours under an environment maintained at 85° C.±2° C., and the rate of performance degradation was confirmed subsequently.

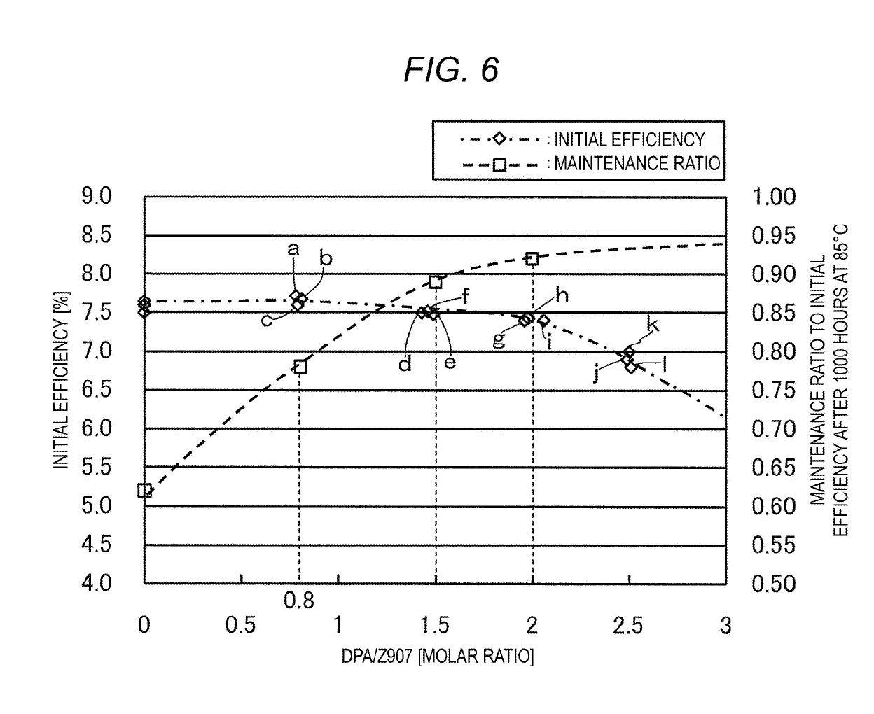

A graph of the measurement results plotted was created with the molar ratio of the adsorbed amount of DPA to the adsorbed amount of Z907, adsorbed on the porous titanium oxide layer, as the horizontal axis, and with the initial efficiency as the vertical axis. In addition, a graph of the measurement results plotted was created with the molar ratio of the adsorbed amount of DPA to the adsorbed amount of Z907 as the horizontal axis, and with the maintenance ratio to the initial efficiency after 1000 hours at 85° C. as the vertical axis. FIG. 6 shows the graph of the measurement results plotted. It is to be noted that in the graph of FIG. 6, the left vertical axis refers to the initial efficiency, whereas the right vertical axis refers to the maintenance ratio to the initial efficiency after 1000 hours at 85° C. Here are the respective molar ratios (DPA/Z907) of points a to 1:

point a: 0.78, point b: 0.81, point c: 0.79, point d: 1.43, point e: 1.49, point f: 1.46, point g: 1.96, point h: 1.98, point i: 2.06, point j: 2.49, point k: 2.50, point l: 2.51

As shown in FIG. 6, when the molar ratio of the adsorbed amount of DPA was increased with respect to the adsorbed amount of Z907 adsorbed on the porous titanium oxide layer, the same level of photoelectric conversion efficiency was maintained up to the molar ratio of 2.0. In the case of greater than the molar ratio of 2.0, there is a tendency to undergo a slight decrease in initial photoelectric conversion efficiency, while there is a tendency to be able to maintain the initial efficiency of 6.0% or more at the molar ratio of 3.0. In addition, at the molar ratio of 0.5 or more, the maintenance ratio is greater than 0.70 shown as a favorable maintenance ratio, and then, the maintenance ratio is also increased with the increase in molar ratio.

### Example 2-1

Except for using, for dye adsorption, a ruthenium-based dye (Z991) in place of Z907, and varying the concentration of the dye solution and the time of immersion in the dye solution, a photoelectric-conversion device was prepared in the same way as in Example 1-1.

### (Measurement of Molar Ratio Between Dye and Coadsorbent)

The porous titanium oxide layer with the dye was peeled from the glass substrate, and used as a measurement sample. The dye and coadsorbent adsorbed on the measurement sample were decomposed by pressurized acid decomposition, and quantitative analysis of Ru and P was performed by ICP-AES. This quantitative analysis figured out the amounts of the dye and coadsorbent per unit volume, which were adsorbed on the porous titanium oxide layer.

As a result, the molar ratio between the 2911 and DPA adsorbed on the porous titanium oxide layer was 2911: DPA=1:0.8. More specifically, the molar ratio of the adsorbed amount of DPA to the adsorbed amount of 2911 was 0.8.

### Example 2-2

Except that the ratio between the adsorbed amounts of the dye and coadsorbent adsorbed on the porous titanium oxide layer was changed by appropriately adjusting, for dye adsorption, the concentration of the dye solution and the time of immersion in the dye solution, a photoelectric-conversion device was prepared in the same way as in Example 2-1. In addition, the amounts of the dye and coadsorbent adsorbed on the porous titanium oxide layer were figured out in the same way as in Example 2-1. As a result, the molar ratio between the Z911 and DPA adsorbed on the porous titanium oxide layer was Z911: DPA=1:1.5. More specifically, the molar ratio of the adsorbed amount of DPA to the adsorbed amount of Z911 was 1.5.

### Example 2-3

Except that the ratio between the adsorbed amounts of the dye and coadsorbent adsorbed on the porous titanium oxide layer was changed by appropriately adjusting, for dye adsorption, the concentration of the dye solution and the time of immersion in the dye solution, a photoelectric-conversion device was prepared in the same way as in Example 2-1. In addition, the amounts of the dye and coadsorbent adsorbed on the porous titanium oxide layer were figured out in the same way as in Example 2-1. As a result, the molar ratio between the Z911 and DPA adsorbed on the porous titanium oxide layer was Z911: DPA=1:2.0. More specifically, the molar ratio of the adsorbed amount of DPA to the adsorbed amount of Z911 was 2.0. In addition, the adsorbed amounts per unit volume onto the porous titanium oxide layer were Z911:1.09 μmol/cm³ and DPA: 2.18 μmol/cm³.

### Comparative Example 2

Except that the dye solution for dye adsorption was made to contain no DPA, a photoelectric-conversion device was prepared in the same way as in Example 2-1.

### (Dark Storage Test at 85° C.)

The dark storage tests at 85° C. were carried out as described above for each of the multiple photoelectric-conversion devices prepared.

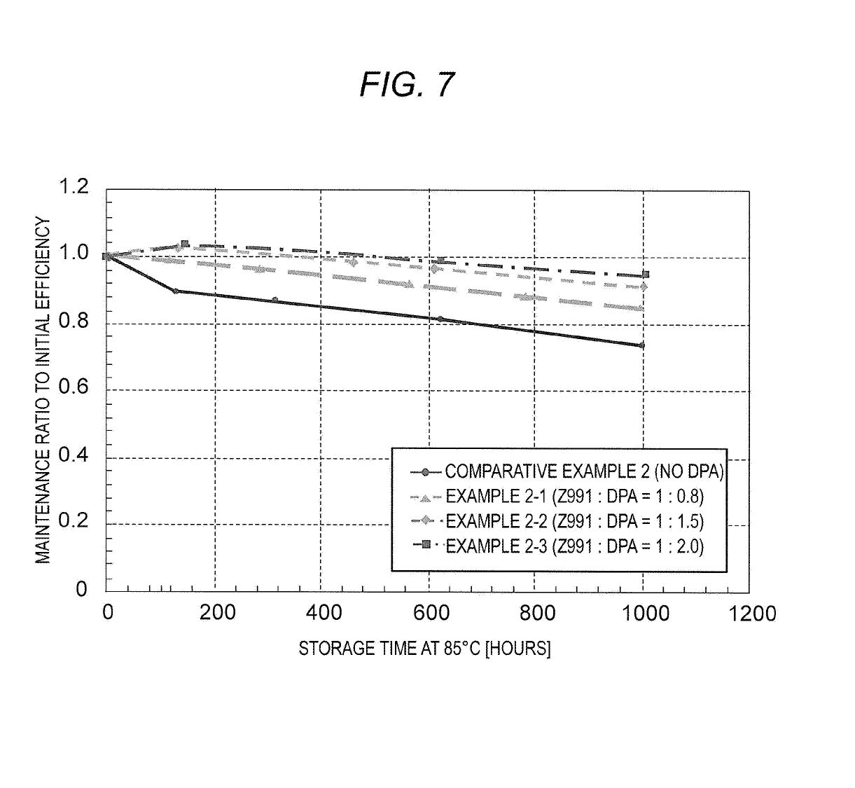

A graph of the measurement results plotted was created with the storage time at 85° C. as the horizontal axis and the maintenance ratio to the initial efficiency as a vertical axis. FIG. 7 shows the graph of the measurement results plotted.

As shown in FIG. 7, in Comparative Example 2, the initial performance declined down to on the order of 70% thereof after 100 hours in the accelerated test at 85° C. for the cell, because of no DPA adsorbed on the porous titanium oxide layer. In contrast, Examples 2-1 to 2-3 have improved performance maintenance ratios after 1000 hours at 85° C., because the molar ratio of the adsorbed amount of DPA to the adsorbed amount of the dye is 0.8 or more with respect to the porous titanium oxide layer. Example 2-1 has succeeded in confirming an improvement up to on the order of 82%, when the molar ratio between Z911 and DPA adsorbed on the porous titanium oxide layer (Z911: DPA) is 1:0.8. Example 2-3 has succeeded in confirming an improvement up to on the order of 98% of the initial performance, when the molar ratio between Z911 and DPA adsorbed on the porous titanium oxide layer (Z911: DPA) is 1:2.0.

### Test Example 2

In addition, the dye concentration of the dye solution and the time of immersion in the dye solution were appropriately adjusted to prepare multiple photoelectric-conversion devices with varied adsorbed amounts of ruthenium-based dye (Z911) and DPA adsorbed on the porous titanium oxide layer.

The following measurements were carried out for each of the multiple photoelectric-conversion devices.

### (Molar Ratio of Adsorbed Amount of DPA to Adsorbed Amount of Z911)

As described above, quantitative analysis of Ru and P was performed by ICP-AES. This quantitative analysis figured out the molar ratio of the adsorbed amount of DPA to the adsorbed amount of Z911 per unit volume, adsorbed on the porous titanium oxide layer.

### (Measurement of Initial Efficiency)

The I-V measurement in the case of pseudo-sunlight (AM 1.5 G, 100 mW/cm²) irradiation with the use of a solar simulator was carried out to measure the initial photoelectric conversion efficiency.

### (Dark Storage Test at 85° C.)

In accordance with the JIS standard for amorphous silicon (JIS C 8983 Environmental Testing Procedure and Durability Testing Procedure for Amorphous Solar Cell Module), an accelerated test was carried out for evaluating long-term performance. More specifically, the photoelectric-conversion device was placed for 1000±12 hours under an environment maintained at 85°±2° C., and the rate of performance degradation was confirmed subsequently.

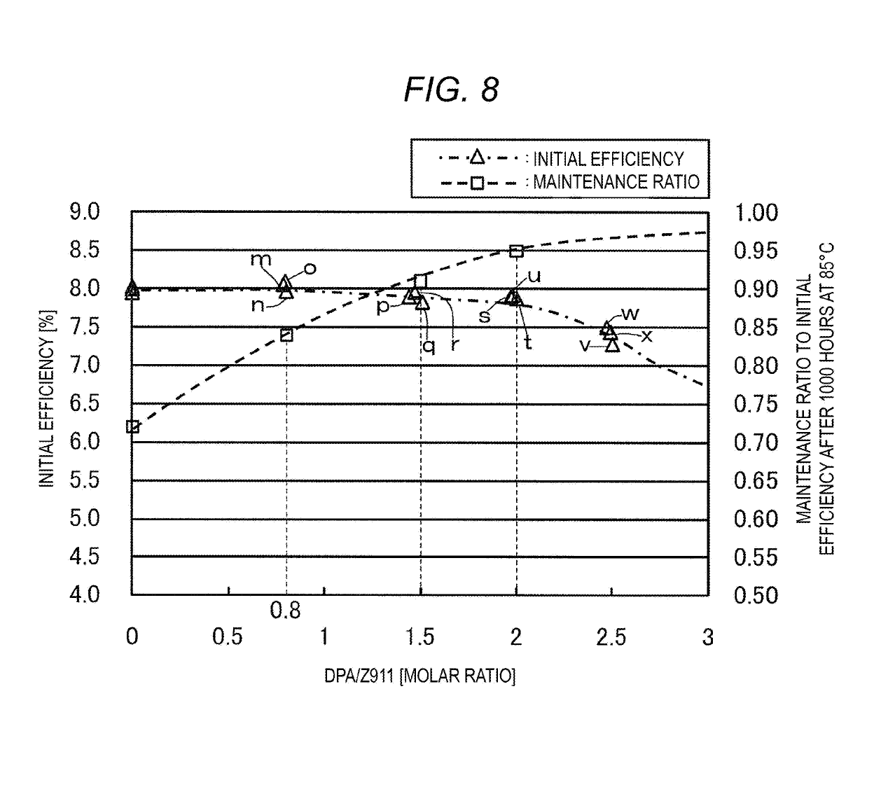

A graph of the measurement results plotted was created with the molar ratio of the adsorbed amount of DPA to the adsorbed amount of Z911, adsorbed on the porous titanium oxide layer, as the horizontal axis, and with the initial efficiency as the vertical axis. In addition, a graph of the measurement results plotted was created with the molar ratio of the adsorbed amount of DPA to the adsorbed amount of Z911 as the horizontal axis, and with the maintenance ratio to the initial efficiency after 1000 hours at 85° C. as the vertical axis. FIG. 8 shows the graph of the measurement results plotted. It is to be noted that in the graph of FIG. 8, the left vertical axis refers to the initial efficiency, whereas the right vertical axis refers to the maintenance ratio to the initial efficiency after 1000 hours at 85° C. Here are the respective molar ratios (DPA/Z911) of points m to x:

point m: 0.785, point n: 0.795, point o: 0.80, point p: 1.44, point q: 1.51, point r: 1.47, point s: 1.97, point t: 2.00, point u: 1.98, point v: 2.50, point w: 2.47, point x: 2.49

As shown in FIG. 8, when the molar ratio of the adsorbed amount of DPA was increased with respect to the adsorbed amount of Z911 adsorbed on the porous titanium oxide layer, the same level of photoelectric conversion efficiency was maintained up to the molar ratio of 2.0. In the case of greater than the molar ratio of 2.0, there is a tendency to undergo a slight decrease in initial photoelectric conversion efficiency, while there is a tendency to be able to maintain the initial efficiency of 6.7% or more at the molar ratio of 3.0. In addition, at the molar ratio of 0.5 or more, the maintenance ratio is greater than 0.77 shown as a favorable maintenance ratio, and then, the maintenance ratio is also increased with the increase in molar ratio.

### 4. Other Embodiments

The present technique is not to be considered limited to the above-described embodiments according to the present technique, and various modifications and applications can be made without departing from the scope of the present technique.

For example, the configurations, methods, steps, shapes, materials, and numerical values, etc. given in the embodiments and examples described above are absolutely by way of example only, and if necessary, other configurations, methods, steps, shapes, materials, and numerical values, etc. may be used which are different therefrom.

In addition, it is possible to combine the configurations, methods, steps, shapes, materials, and numerical values, etc. given in the embodiments described above with each other, without departing from the scope of the present technique.

In addition, the multiple photoelectric-conversion devices (cells) according to the embodiments described above may be combined to form a module. The multiple photoelectric-conversion devices are electrically connected in series and/or parallel, and for example, when the devices are combined in series, a high voltage can be achieved.

Furthermore, the present technique can also provide the following configurations.

[1]

A photoelectric-conversion device including:

a conductive layer;

a porous semiconductor layer;

a counter electrode; and

an electrolyte layer,

wherein the porous semiconductor layer includes a dye and a phosphorous compound represented by the general formula (A), and

the molar ratio of the phosphorous compound to the dye is 0.5 or more.

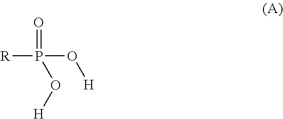

(In the formula, R is a linear alkyl group having 8 to 16 carbon atoms.)
[2]

The photoelectric-conversion device according to [1], wherein the phosphorous compound is a decylphosphonic acid represented by the formula (1).

[3]

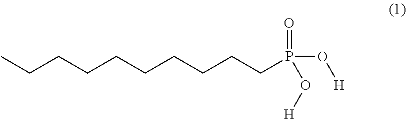

The photoelectric-conversion device according to any of [1] to [2], wherein the dye is a ruthenium complex dye.

[4]

The photoelectric-conversion device according to [3], wherein the ruthenium complex dye is at least one of ruthenium complex dyes represented by the formula (2) and the formula (3).

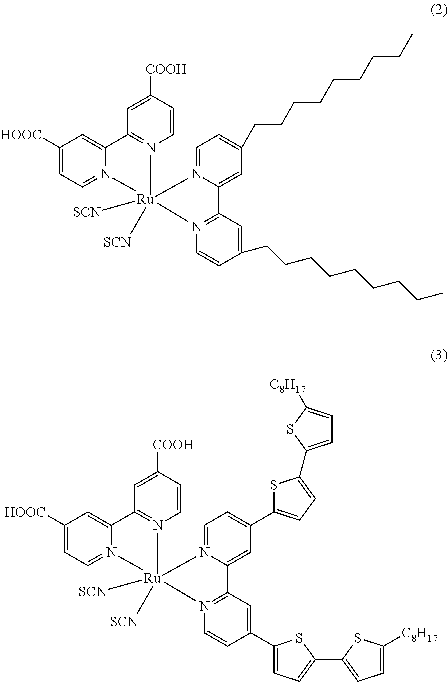

[5]

The photoelectric-conversion device according to any of [1] to [4], the molar ratio of the phosphorous compound to the dye is 3.0 or less.

[6]

The photoelectric-conversion device according to any of [1] to [5], wherein the dye and the phosphorous compound are adsorbed onto the porous semiconductor layer.

[7]

An electronic instrument including the photoelectric-conversion device according to any of [1] to [6].

[8]

A building including the photoelectric-conversion device according to any of [1] to [6].

### REFERENCE SIGNS LIST

1, 2 Conductive base material
3 Porous semiconductor layer
4 Electrolyte layer
5 Counter electrode
6 Sealing material
11, 21 Base material
12, 22 Transparent conductive layer
43 Current collector
45 Protective layer

1. A photoelectric-conversion device comprising:
a conductive layer;
a porous semiconductor layer;
a counter electrode; and
an electrolyte layer,
wherein the porous semiconductor layer includes a dye and a phosphorous compound represented by the general formula (A), and
the molar ratio of the phosphorous compound to the dye is 0.5 or more. 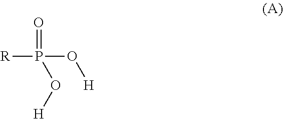
(In the formula, R is a linear alkyl group having 8 to 16 carbon atoms.)

2. The photoelectric-conversion device according to claim 1, wherein the phosphorous compound is a decylphosphonic acid represented by the formula (1).

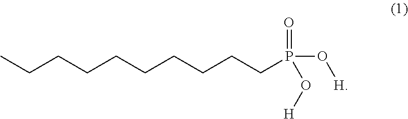

3. The photoelectric-conversion device according to claim 1, wherein the dye is a ruthenium complex dye.

4. The photoelectric-conversion device according to claim 3, wherein the ruthenium complex dye is at least one of ruthenium complex dyes represented by the formula (2) and the formula (3).

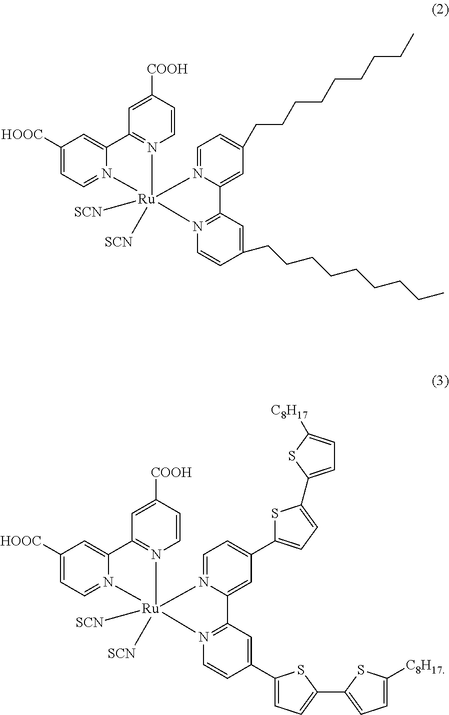

5. The photoelectric-conversion device according to claim 1, wherein the molar ratio of the phosphorous compound to the dye is 3.0 or less.

6. The photoelectric-conversion device according to claim 1, wherein the dye and the phosphorous compound are adsorbed onto the porous semiconductor layer.

7. An electronic instrument comprising the photoelectric-conversion device according to claim 1.

8. A building comprising the photoelectric-conversion device according to claim 1.
